(19) United States
(12) Patent Application Publication
(10) Pub. No.: US 2002/0053142 A1
(43) Pub. Date: May 9, 2002

(54) Window and door trim square

(76) Inventor: Mark Brunetti, Jessup, PA (US)

Correspondence Address: Richard C. Litman, LITMAN LAW OFFICES, LTD., P.O. Box 15035, Arlington, VA, 22215, US

(21) Appl. No.: 09/985,908

(22) Filed: Nov. 6, 2001

Related U.S. Application Data
(60) Provisional application No. 60/246,603, filed on Nov. 8, 2000.

(51) Int. Cl. E04F 21/00; B43L 7/027

(52) U.S. Cl. 33/194; 33/474

(57) ABSTRACT

A geometric instrument useful as a carpentry tool. The invention is a square of thick aluminum plate in the shape of a right isosceles triangle with a handle fitted and perpendicular to the hypotenuse. A rabbet cut is made in the edges of equal sides of the triangular carpenter's square. A second embodiment employs adjustable feeler bars in place of the rabbet cut for checking the square of window and door jambs. Also, the miters or feeler bars facilitate the laying out of short points on the jams for miter cutting.

### CROSS-REFERENCE TO RELATED APPLICATION

This application claims the benefit of U.S. Provisional Patent Application Ser. No. 60/246,603, filed Nov. 8, 2000.

### BACKGROUND OF THE INVENTION

1. Field of the Invention

The present invention relates to a carpenter's woodworking tool for window and door trim work. More particularly, the present invention relates to a window and door trim square for checking the square of window and door trim, marking short points for miter cuts, and for leaving depth of the trims reveal.

2. Description of Related Art

It has long been a problem for carpenters to check the square of window and door trim, especially those located far overhead. Ladders are necessary, and an ordinary carpenter's square is difficult to handle in this situation, especially for window and door trim molding where a number of steps are carved or routed into the molding. Also, it is difficult to lay out short points on trim, while keeping a level straight prior to miter cutting for installation.

A number of variations on carpenters' squares and the like are known. U.S. Design Pat. No. 416,210, issued Nov. 9, 1999 to Johnson, pictorially describes a tool apparently useful for checking trim square having a handle for easy grasping. The handle in the '210 Patent does not, however, have a significant reach for reaching high-mounted trim, and has no feeler feature for accurate checking of intricate trim moldings, such as door casing, window casing, and point and block trim moldings, and to facilitate the laying out of short points on trim for miter cutting.

U.S. Pat. No. 4,404,753, issued Sep. 20, 1983 to Klok, describes a carpenter's square having a heel flange midway along the hypotenuse for continually marking angles along a piece of material. The '753 patent fails to describe an extended handle for checking the square of overhead trim, and the heel flange would not be useful as a feeler for checking intricate trim moldings.

U.S. Pat. No. 4,443,953, issued Apr. 24, 1984 to Gregory, provides a squaring device having a handle mounded perpendicularly to the planar surface, apparently to promote its use on a flat surface, such as in drafting. The square of the '953 Patent would not be advantageously useful for checking overhead trim square as the handle does not project out along the same plane as the planar portion of the square, thus making it difficult to use for checking the square of overhead trim, nor would it be advantageous to facilitate the laying out of short points on trim for miter cutting.

U.S. Pat. No. 5,349,758, issued Sep. 27, 1994 to Bear, describes a combination tool that is useful for checking the square of trim, etc. and has a handle portion in the same plane as the planar surface of the square, the square having protruding flanges underneath and parallel to the side legs of the square. The handle of the '758 tool, however, extends from the square from a direction which would make it useful for checking trim square even with or below the user, but would not be useful above the user's head. The protruding flanges are not adjustable to accommodating varying types of door and window trim casings.

U.S. Pat. No. 5,575,074, issued Nov. 19, 1996 to Cottongim et al., describes a square device having a flange along one side edge. No handle is provided with this square, and the flange, in its disclosed position, would not increase its effectiveness in checking the square of trim or to facilitate the laying out of short points on trim for miter cutting.

U.S. Pat. No. 5,836,198, issued Nov. 17, 1998 to Guilford, describes a square having a groove along one side useful in bending metal. The '198 Patent fails to provide a handle for extending it into overhead trim intersections for checking square, and there is no provision for providing a feeler for checking casing or trim-type moldings or to facilitate the laying out of short points on trim for miter cutting.

None of the above inventions and patents, taken either singly or in combination, is seen to describe the instant invention as claimed.

### SUMMARY OF THE INVENTION

The present invention is a geometric instrument useful as a carpentry tool. The invention is a square of thick aluminum plate in the shape of a right isosceles triangle with a handle fitted and perpendicular to the hypotenuse. A rabbet cut is made in the edges of equal sides of the triangular carpenter's square. A second embodiment employs adjustable feeler bars in place of the rabbet cut for checking the square of moldings. Also, the miters or feeler bars facilitate the laying out of short points on trim for miter cutting.

Accordingly, it is a principal object of the invention to provide a carpenter's square useful in checking the square of door and window trim or molding and which is accurate and easy to use.

It is another object of the invention to provide a carpenter's square comprising a triangular body in the shape of a right isosceles triangle, and having a handle extending outward from the triangular portion at a point along the hypotenuse of the triangular portion, the handle being of such length as to allow a carpenter to easily check overhead door and window square.

It is a further object of the invention to provide a LITMAN LAW carpenter's square as above where the handle bisects and is perpendicular to the hypotenuse of the triangular portion.

Still another object of the invention is to provide a carpenter's square having a rabbet cut along each side so as to fit or lock on door and window jams to mark the reveal.

It is yet another object of the invention to provide a carpenter's square having feeler bars mounted on the triangular portion parallel to each triangle side and which are adjustable, toward and away from the two sides while remaining parallel to the sides, so as to allow easily checking of ornate moldings for square, and marking different sized reveal.

It is still another object of the invention to provide a carpenter's square which is useful in laying out short points on uncut trim while keeping the level straight prior to miter cutting trim.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a window and door trim square according to the present invention.

FIG. 2 is a cut away view of the inventive square of FIG. 1 showing the rabbet cut.

FIG. 3 is an elevation view of the back of the inventive square of FIG. 1.

FIG. 4 is an environmental view in perspective showing another embodiment of the inventive square.

FIG. 5 is an environmental view in perspective showing the embodiment of FIG. 4 used in a reverse mode.

FIG. 6 is an exploded view of the back of the inventive square of FIG. 4.

FIG. 7 is an elevation view of the back of the inventive square of FIG. 4 with feeler bars located at unequal positions.

Similar reference characters denote corresponding features consistently throughout the attached drawings.

### DETAILED DESCRIPTION OF THE PREFERRED EMBODIMENTS

The present invention is a geometric instrument useful as a carpentry tool. The invention is a square of thick aluminum plate in the shape of a right isosceles triangle with a handle perpendicular to the hypotenuse. A rabbet cut is made in the edges of equal sides of the triangular carpenter's square. A second embodiment employs adjustable feeler bars in place of the rabbet cut for checking the square of moldings. Also, the miters or feeler bars features and the handle facilitate the laying out of short points on trim for miter cutting, and reveal size.

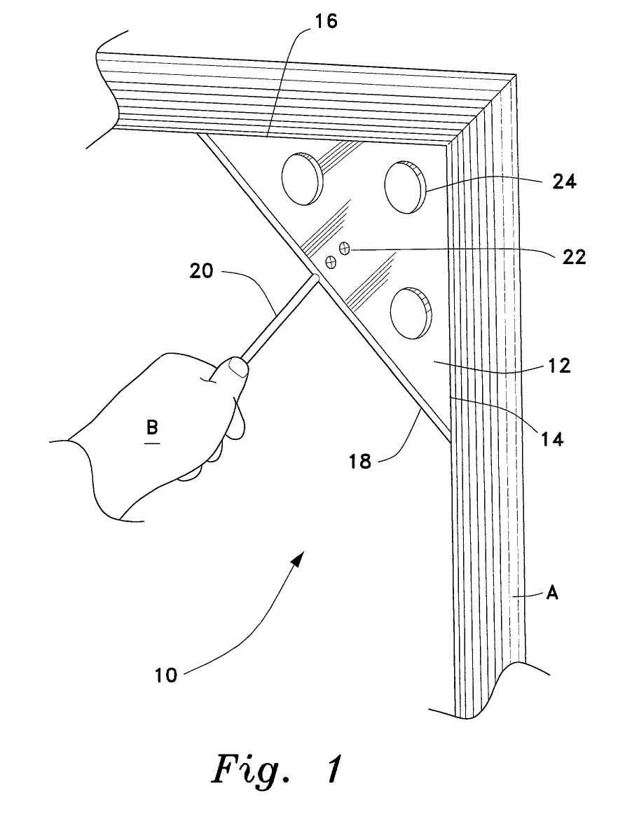

Referring to FIG. 1, the carpenter's square 10 of the present invention is shown checking the square of trim A by user B. The square 10 features a triangular carpenter's square 12 having sides 14 and 16 of equal length and side 18 forming the hypotenuse of a right isosceles triangle. Handle 20 bisects and is mounted perpendicular to side 18 and is connected to square 12 by fasteners 22. Square 12 defines one or more apertures 24 which lighten square 12 and allow partial visibility through the square.

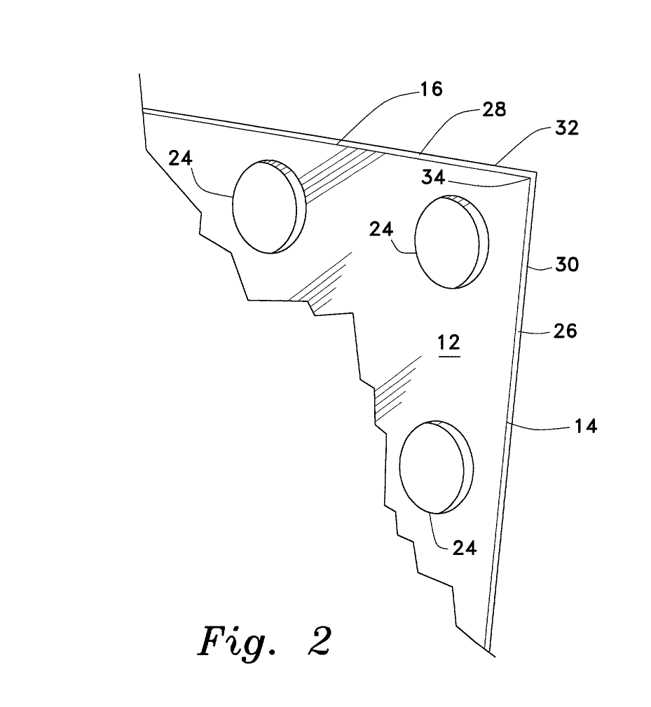

Referring to FIG. 2, there is shown a broken away portion of square 12 where sides 14 and 16 feature lips 26 and 28, respectively (hidden in FIG. 1), created by means such as a rabbet cut along the edges of sides 14 and 16. Lips 26 and 28 have outer edges 30 and 32, respectively and intersect at point 34. The lips 26 and 28 and intersection point 34 assist in using the square 12 for marking trim for miter cutting by creating a pivot point around which square 12 can be rotated during reveal marking. A preferred size of the rabbet cut is about ⅛ by ⅛ inches (it is a common practice to leave a reveal on the casing on door and window trim about ⅛ inch from the edge of the jamb), thus, forming lips 26 and 28. The rabbet cut enables the square to be checked on casing which forms a relief with the jamb.

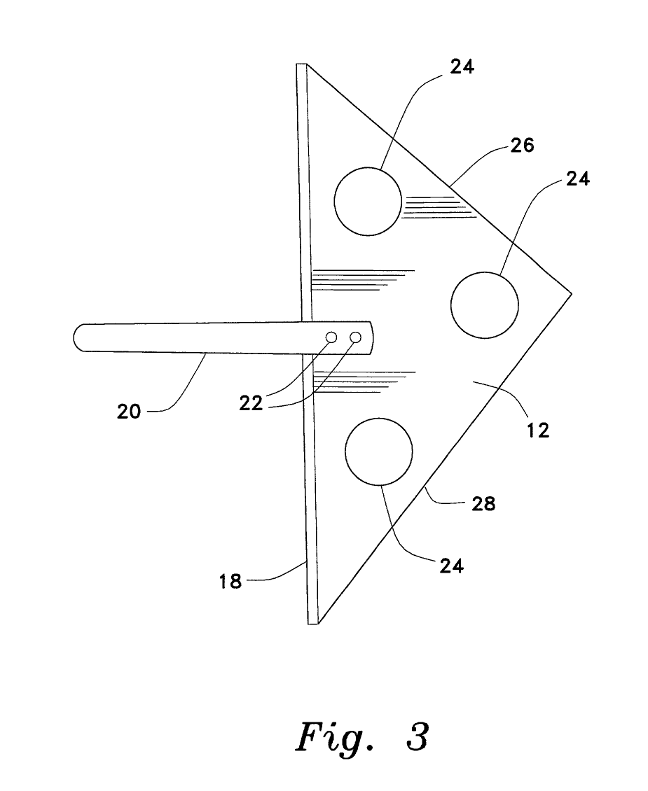

Referring to FIG. 3, there is shown the reverse side of square 12 where only outer edges 26 and 28 can be seen. Handle 20 is shown attached to square 12 perpendicular to side 18 by fasteners 22. Handle 20 is shown as a cylindrical rod, but may be any other shape comfortable for gripping.

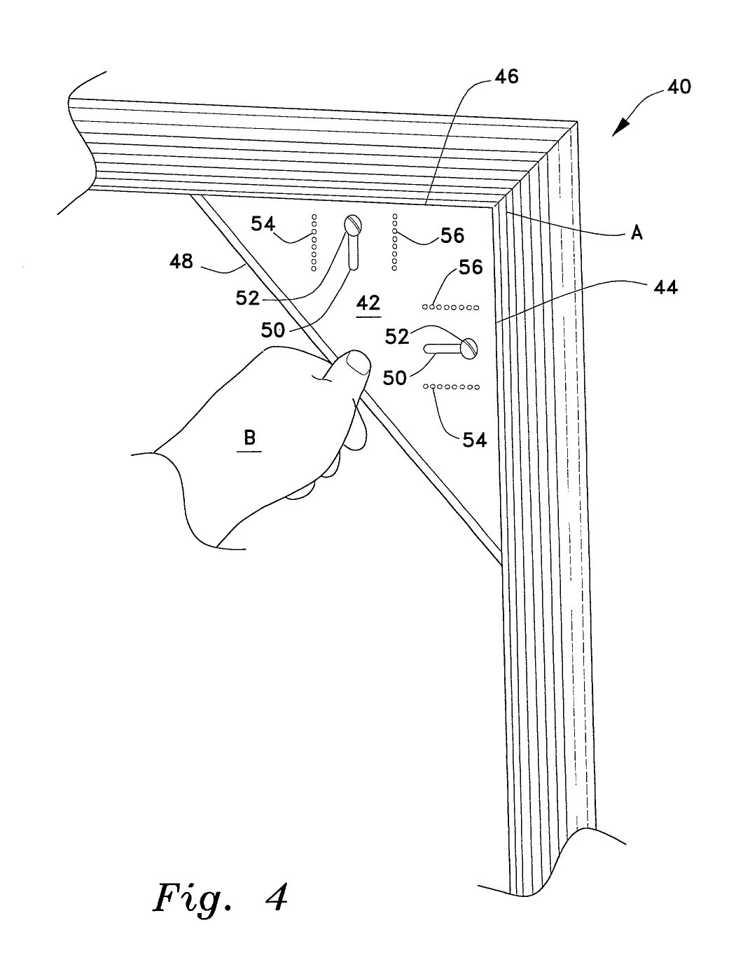

Referring to FIG. 4, there is shown another embodiment of the carpenter's square of the present invention. Square 40 is illustrated checking the square of trim A and marking trim reveals by user B. Square 40 features triangular square 42 having sides 44 and 46 of equal length, side 48 acting as a hypotenuse completing a right isosceles triangle. Slots 50 are located inboard and perpendicular to sides 44 and 46, respectively, and provide for adjustable travel for fasteners 52, which are typically screws. Linearly disposed multiple pin holes 54 and 56 are equally spaced from and parallel to slots 50. The pinholes form a series of pairs, each pair defining a line parallel to a corresponding side.

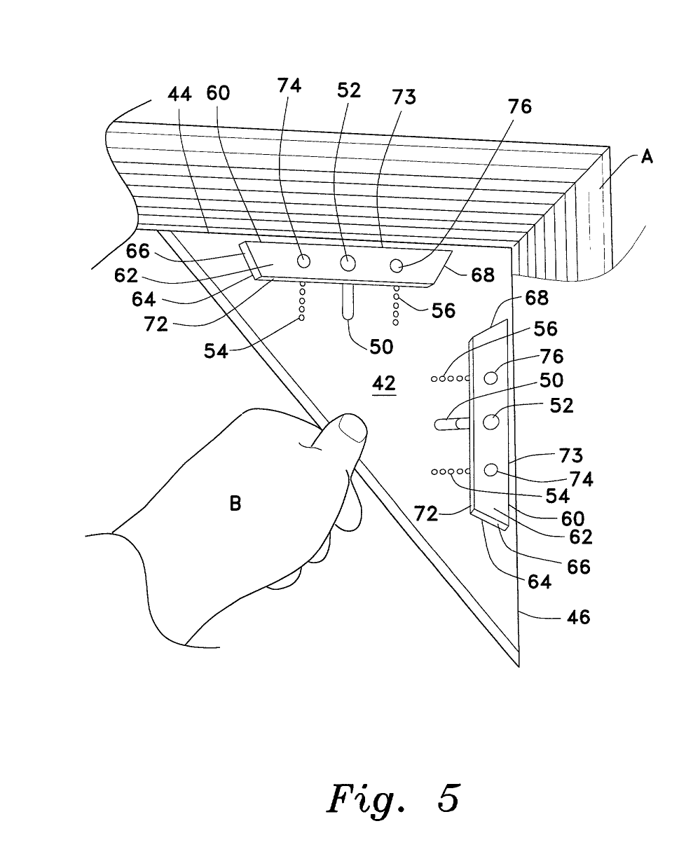

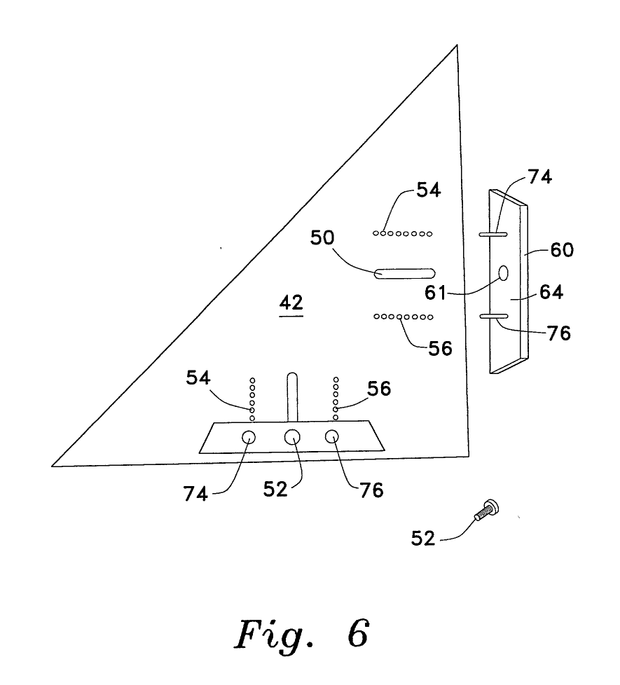

Referring to FIGS. 5 and 6, there is shown the reverse side of triangular carpenter's square 42 where feeler bars 60 are adjustably mounted parallel to edges 44 and 46 by means of fasteners 52 located in grooves 50. Feeler bars 60 feature upper surfaces 62, lower surfaces 64, outer ends 66 and inner ends 68, and inner edges 72, and outer edges 73, respectively. As better seen in FIG. 6, feeler bars 60 feature outer pins 74 and inner pins 76 protruding from under sides 64 so located as to fit in corresponding pinhole pairs in the multiple linearly disposed outer pinholes 54 and inner pinholes 56. Feeler bars 60 have a centrally located threaded aperture 61 for receiving fasteners 52.

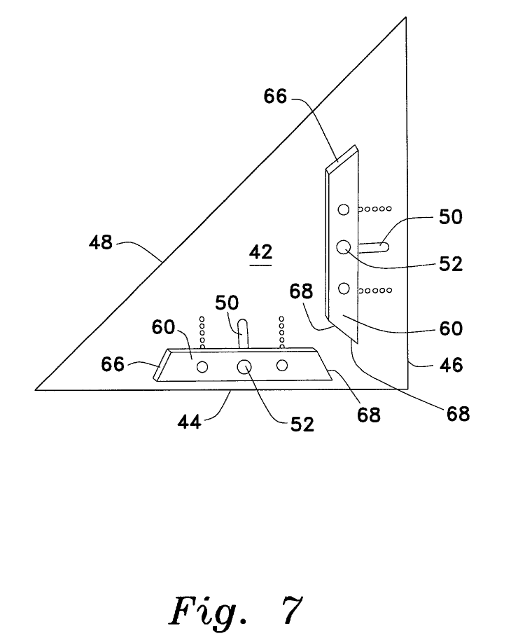

Referring to FIG. 7, there is illustrated a mode of adjustment of triangular square 42 where feeler bars 60 are set at unequal distances from their respective square edges 44 and 46. The feeler bars may be set at equal distances from square edges 44 and 46 if desired. It is noted that outer feeler bar ends 66 are mitered at an angle of 45° relative to the inner and outer edges 72 and 73 of feeler bars 60 and that inner feeler bar ends 68 are mitered at an opposite angle of 45° relative to inner and outer edges 72 and 73 such that upon innermost adjustment, outer feeler bar ends 66 are coplanar or flush with square side 48, and inner feeler bar ends 68 are abut, forming a 90 degree angle. In this mode of adjustment the square 42 is most useful for facilitating the laying out of short points and reveals on trim for miter cutting as the square 42 may be rotated around the point formed at the intersection of outer edges 73 of feeler bars 60.

Adjustment of feeler bars 60 is accomplished by unscrewing fasteners 52 from apertures 61, thus, freeing feeler bars 60 so that they may be lifted from the surface of triangular square 42. Pins 74 and 76 are placed in the desired pinholes 54 and 56 to achieve the desired spacing of feeler bars 60 from sides 44 and 46. Fasteners 52 are then screwed into apertures 61 so as to be located through slots 50, and then tightened to a desired torque to achieve required integrity of the square during use. It is preferred that the feeler bars 60 are adjustable from a point proximate their respective sides 44 and 46 to a point allowing about one inch between each feeler bar 60 and its respective side 44 or 46. A handle may be mounted on the triangular portion of this embodiment similar to that shown in the embodiment of FIGS. 1, 2, and 3, above if desired.

It is recognized that any appropriate material may be used in the construction of the above described embodiments of the present invention, such as metal, wood, or plastic as desired. Also, the size of the respective elements of the present invention may be varied and are a matter of choice.

It is to be understood that the present invention is not limited to the embodiments described above, but encompasses any and all embodiments within the scope of the following claims.

I claim:

1. A carpenter's square comprising:
a triangular body in the shape of a right isosceles triangle and having first and second sides of equal length, and a third side corresponding to the hypotenuse of said right isosceles triangle;
said first and second sides each having an outer edge;
said triangular body having a front face and a rear face; and
recessed means for abutting the square against door and window trim forming a reveal with a jamb.

2. The carpenter's square according to claim 1, further comprising a handle affixed to and extending outward from said triangular portion at a point along said third side.

3. The carpenter's square according to claim 2, wherein said handle has a length and is sized and dimensioned so as to allow a carpenter to easily check overhead door and window trim square.

4. The carpenter's square according to claim 2, wherein said handle bisects and is disposed perpendicular to said third side of said triangular portion.

5. The carpenter's square according to claim 1, wherein said recessed means comprises a rabbet cut defined in the outer edge of each of said first and second sides on said rear face of said triangular body.

6. The carpenter's square according to claim 1, wherein said recessed means comprises a pair of feeler bars each having inner and outer ends and mounted on the rear face of said triangular body, said feeler bars being mounted on said first and second sides and parallel to each of said first and said second sides, respectively, each said feeler bar having a threaded aperture defined therein.

7. The carpenter's square according to claim 6, wherein said feeler bars are adjustably mounted for positioning toward and away from the edges of said respective first and second sides while remaining parallel therewith.

8. The carpenter's square according to claim 7, wherein said triangular body defines slots corresponding to said feeler bars, said slots being perpendicular and spaced from said first and second sides, said carpenter's square further comprising a pair of fasteners, said slots being so configured that the said fasteners extend through said slots to mate with said threaded apertures in said feeler bars, whereby said fasteners are loosened or removed from said slots to allow adjustment of position of their respective feeler bars, and replaced and tightened to lock their respective feeler bars in place.

9. The carpenter's square according to claim 8, wherein said triangular body defines a pair of rows of spaced apart pinholes, each pair of rows being disposed perpendicular to a corresponding one of said first and second sides, each said row being spaced from opposite sides of said slots and parallel thereto, and wherein each said feeler bar further comprises a pair of pins disposed on opposite sides of each said threaded aperture and spaced therefrom and so positioned to engage a selected pair of pinholes, whereby said feeler bars may be recessed from said outer edges of said first and second sides at selected discrete, predetermined intervals.

10. The carpenter's square according to claim 9, wherein said pinholes are defined as a series of pairs, each pair defining a line parallel to said corresponding side, and wherein each pair of pins are so positioned as to engage one of said series of pairs of pinholes.

11. The carpenter's square of claim 10, wherein said inner end of each said feeler bar is miter cut at an angle of 45° such that said feeler bar ends are capable of engaging to form a right angle.

12. The carpenter's square of claim 11, wherein said outer end of each said feeler bars are miter cut at an opposite angle of 45° relative to said miter cut of said inner end.

13. The carpenter's square of claim 12 wherein each said feeler bar is independently adjustable so as to be positionable such that said feeler bars are positioned at different distances from their corresponding sides.

14. A carpenter's square comprising:
a triangular body in the shape of a right isosceles triangle and having first and second sides of equal length, and a third side corresponding to the hypotenuse of said right isosceles triangle;
said first and second sides each having an outer edge;
said triangular body having a front face and a rear face;
recessed means for abutting the square against door and window trim forming a reveal with a jamb; and
a handle affixed to and extending outward from said triangular portion at a point along said third side;
said handle having a length and being sized and dimensioned so as to allow a carpenter to easily check overhead door and window trim square;
said handle bisecting and being disposed perpendicular to said third side of said triangular portion;
said recessed means comprising a rabbet cut defined in the outer edge of each of said first and second sides on said rear face of said triangular body.
